(19) United States
(12) Patent Application Publication
(10) Pub. No.: US 2023/0269435 A1
(43) Pub. Date: Aug. 24, 2023

(54) SYSTEM AND METHOD FOR THE CREATION AND MANAGEMENT OF VIRTUALLY ENABLED STUDIO

(71) Applicant: HARMAN INTERNATIONAL INDUSTRIES, INCORPORATED, Stamford, CT (US)

(72) Inventors: Kyle David KRAMER, Waterford, MI (US); Maxwell B. WILLIS, Royal Oak, MI (US); Christopher Michael TRESTAIN, Livonia, MI (US); Chris LUDWIG, Bloomfield Hills, MI (US); Riley WINTON, Opelika, AL (US)

(73) Assignee: HARMAN INTERNATIONAL INDUSTRIES, INCORPORATED, Stamford, CT (US)

(21) Appl. No.: 18/015,839

(22) PCT Filed: Jul. 19, 2021
(86) PCT No.: PCT/US2021/042195

§ 371 Date: Jan. 12, 2023

Related U.S. Application Data
(60) Provisional application No. 63/053,318, filed on Jul. 17, 2020.

(51) Int. Cl. H04N 21/4784; H04N 23/661; H05B 47/155; G06Q 10/02; H04N 21/2187; H04N 21/485; H04N 21/4788; H04N 23/90

(52) U.S. Cl. CPC H04N 21/4784; H04N 23/661; H05B 47/155; G06Q 10/02; H04N 21/2187; H04N 21/4852; H04N 21/4788; H04N 23/90

(57) ABSTRACT

In at least one embodiment, a system for controlling aspects of a virtual concert is provided. The apparatus includes one or more controllers and at least one computing device. The one or more controllers are positioned in a venue and are configured to control features of a live performance at the venue based on at least one first signal. The at least one computing device is programmed to receive a second signal indicative of a command to control at least a portion of the live performance from directly from a user that is remote from the venue and to transmit the at least one first signal to the one or more controllers to control the features of the live performance.

### CROSS-REFERENCE TO RELATED APPLICATIONS

This application claims the benefit of U.S. provisional application Ser. No. 63/053,318 filed Jul. 17, 2020, the disclosure of which is hereby incorporated in its entirety by reference herein.

### TECHNICAL FIELD

Aspects disclosed herein generally relate to a system and method for creating and managing a virtually enabled studio. In certain embodiments, aspects disclosed herein may correspond to a system and method for creating and managing a virtually enabled studio in which users can interact remotely via connected devices that provide a real output in the studio. These aspects and others will be discussed in more detail below.

### BACKGROUND

There may be an inability for users to participate in live concerts at real concert venues. For example, users may not be able to participate in a live concert for a variety of reasons. For example, due to the recent pandemic, large crowds were prohibited from gathering in small spaces for concerts. Additionally, without concerns of a pandemic, it's possible that concert goers (or fans) cannot attend a concert due to the location or distance between the concert venue and the location of the fan. It may be desirable to enable users the ability to control any number of facets related to a live performance that are based on the fan's preferences while experiencing such aspects remotely at a different location from the location of the actual live performance.

### SUMMARY

In at least one embodiment, a system for controlling aspects of a virtual concert is provided. The apparatus includes one or more controllers and at least one computing device. The one or more controllers are positioned in a venue and are configured to control features of a live performance at the venue based on at least one first signal. The at least one computing device is programmed to receive a second signal indicative of a command to control at least a portion of the live performance from directly from a user that is remote from the venue and to transmit the at least one first signal to the one or more controllers to control the features of the live performance.

In at least another embodiment, a method for controlling aspects of a virtual concert is provided. The method includes controlling, via one or more controllers positioned in a venue, features of a live performance at the venue based on at least one first signal and receiving, at at least one computing device, a second signal indicative of a command to control at least a portion of the live performance from directly from a user that is remote from the venue. The method further includes transmitting the at least one first signal to the one or more controllers to control the features of the live performance.

In at least another embodiment, a computer-program product embodied in a non-transitory computer read-able medium that is programmed for controller aspects of a virtual concert. The computer-program product includes instructions for controlling, via one or more controllers positioned in a venue, features of a live performance at the venue based on at least one first signal and receiving, at at least one computing device, a second signal indicative of a command to control at least a portion of the live performance from directly from a user that is remote from the venue. The computer-program product includes instructions for transmitting the at least one first signal to the one or more controllers to control the features of the live performance.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompany drawings in which:

FIG. 1 depicts a system for creating and managing a virtually enabled studio or live performance in accordance with one embodiment;

FIG. 2 depicts a method for controlling one or more cameras for a virtually enabled studio or for a live performance in accordance with one embodiment;

FIG. 3 depicts a method for controlling lighting in a virtually enabled studio or for a live performance in accordance with one embodiment;

FIG. 4 depicts a method for controlling one or more props for a virtually enabled studio or for a live performance in accordance with one embodiment;

FIG. 5 depicts a method for controlling miscellaneous activities for a virtually enabled studio or for a live performance in accordance with one embodiment;

FIG. 6 depicts a method for determining a prestige among a first user and a second user when contradictory commands are provided for controlling aspects related to the virtually enabled stereo or live performance in accordance with an embodiment;

FIG. 7 depicts examples of cheer credits that may be issued by the system of FIG. 1 in accordance with one embodiment;

FIG. 8 depicts additional examples of cheer credits that may be issued by the system of FIG. 1 in accordance with one embodiment;

FIG. 9 depicts examples of ticket tiers that may be issued by the system of FIG. 1 in accordance with one embodiment;

FIG. 10 depicts examples of exclusive features that may be issued by the system of FIG. 1 in accordance with one embodiment;

FIG. 11 depicts examples of exclusive offers that may be issued by the system of FIG. 1 in accordance with one embodiment;

FIG. 12 depicts examples of playlist events that may be issued by the system of FIG. 1 in accordance with one embodiment;

FIG. 13 depicts examples of playlist events that may be issued by the system of FIG. 1 in accordance with one embodiment;

FIG. 14 depicts an illustrative user interface on one or more computing devices of the system of FIG. 1 in accordance with one embodiment;

FIG. 15 depicts a system for remotely creating an audio/video mix and a master of live audio and video stream in accordance with an embodiment;

FIG. 16 depicts an interface screen as provided by the computing device of the system of FIG. 15 in accordance with an embodiment;

FIG. 17 depicts a method for time aligning audio and video streams from a live performance in accordance with one embodiment; and

FIG. 18 depicts a method for providing a “picture-in-picture stream” for a live performance in accordance with one embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It is recognized that at least one controller (or at least one processor) as disclosed herein may include various microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, the at least one controller as disclosed herein utilize one or more microprocessors to execute a computer-program that is embodied in a non-transitory computer readable medium that is programmed to perform any number of the functions as disclosed. Further, the controller(s) as provided herein includes a housing and the various number of microprocessors, integrated circuits, and memory devices ((e.g., FLASH, random access memory (RAM), read only memory (ROM), electrically programmable read only memory (EPROM), electrically erasable programmable read only memory (EEPROM)) positioned within the housing. The disclosed controller(s) also include hardware-based inputs and outputs for receiving and transmitting data, respectively from and to other hardware-based devices as discussed herein.

### System and Method for Creating and Managing a Virtually Enabled Studio or Live Performance

Aspects disclosed herein generally provide, but not limited to, an entire music venue as a live streaming studio, including lighting, audio miking, amplification, videography, projection, etc. to provide an online virtual concert experience. This technology and implementation may not be limited for a virtual concert but may also be used for any live streamed event. Remote users may be able to control and trigger many different physical devices in the venue by issuing commands online, via chat. These commands trigger real world events to occur at the location of the stream (or live performance), in real time.

At the heart of this technology is a main server (“server”) (or at least one controller) with many nodes that are provided. The server may include any number of microprocessors to execute instructions to perform any of the functions noted herein. In one example, the server may be any type of online connected computer device that has the ability to transmit commands (e.g., messages) to any number of nodes. Each node may include one or more of a microcontroller, a computer, a mobile device (e.g., cell phone, tablet) that is configured to interpret commands (messages) from the server and execute commands associated with the command (or message). The server may interpret keywords that are transmitted in a chat (e.g., an Internet Relay Chart (IRC)) related to a streaming service (e.g.., Chat Bot). This service may interpret messages that are transmitted by the user who desires to trigger events to occur in the concert venue or studio where the event is being held. In another embodiment, the user is trigging events via the user interface of the computing device and the server interprets such responses or commands to reproduce them in the streaming venue. The server includes a database to collect the responses or commands that are transmitted to the venue. The server aggregates the data that is transmitted as commands to the venue and may also transmit the data back to other computing devices. One example may involve the transmission of an interactions (e.g., emoji, cheer, vote, or any other type of user interaction) from a first computing device to be displayed at a display in the venue. The server may also transmit the interactions to other computing devices for viewing on such other computing devices if desired by the user.

An online currency may also be created for the event in exchange for local currency. Once exchanged, a user may be able to spend this currency during the event to trigger desired events associated with the live performance. Also, depending upon which tier of access a user purchases when joining the video stream, the users may be awarded a specific tier of prestige. Such a level of prestige grants users access to additional events they are permitted to trigger in the studio/venue where the live venue is taking place.

If a user intends to trigger a desired event at the live performance, the server may determine if the user has the proper prestige and balance needed to trigger such a desired event. Once determined, the server may either transmit proper messages to trigger the event or the server may bounce the message back to the users thereby informing the users that they lack either the prestige, balance, or both to trigger such an event. This currency may also be awarded to users for different events. The currency may also be used to purchase different merchandise from an exclusive store available either before, during, or after the event. In one example, such purchases may only be allowed during the event.

The location from which the live stream takes place (e.g., the venue for the live stream) may be equipped with a plurality of nodes (e.g., plurality of electronic nodes) that may be controlled by the remote user. The nodes may include, but not limited to, pyrotechnics, cameras, robotics, hydraulics, stage lighting, audience lighting, stage lighting animations, audio, animations rendered on the stream, as well as trigger animations to place on a large screen visible in the location, text to be displayed on the screen in the venue, emojis on the screen in the venue, etc. The nodes may be equipped with a computer, mobile device (e.g., phone, tablet, etc.) that each include any number of microcontrollers to translate messages/commands from the server and translate such commands into digital or analog messages (e.g., serial, Digital Multiplex (DMX), Inter-Integrated Circuit (I2C), User Datagram Protocol (UDP), JavaScript Object Notation (JSON)), relays, voltage, current, resistance, capacitance, inductance, magnetic and electric fields, etc.) to properly control the event requested by the user. Nodes may be used to hold video calls using a camera and microphone of choice by the user. Also, for the exclusive contact to provide a private experience to a selected user or group of users. The nodes may be positioned in any number of locations in the venue, for example, on stage, backstage, in the green room, in the concert hall, in audience boxes, on the mezzanine, etc. to be utilized for additional exclusive video calls to bring users “On Stage” or “Backstage” or additional places throughout the venue. The video call can also be used to capture a user and be used as an additional data point that is represented in the venue. For example, a captured image of a user's face or other data from their camera may be shared to other users and be used as a data point to be reproduced in an interesting way (e.g., how the fans are responding to the concert and capturing the fan's response).

The server may also provide ways for users to participate in events throughout the live streaming event. Users may be prompted with a way to access the server and to log in via their personal device. Once given access, a user interface may be displayed which allows the user to participate in the event taking place in the live stream/venue. These events may include, but are not limited to, drawing an animation across the screen in the venue, tap to a beat, taking a live survey, answering trivia questions, logging user inputs, rendering the user inputs in the venue, turn a spotlight, follow the leader, interact with a streaming artist, etc.

Embodiments disclosed herein generally provide for a novel experience for users to interface with a live performance remotely from the location in which the live performance takes place. For example, users may be able to interact and participate in an event together with their favorite artists like never before. Using the implementations noted herein, a venue or studio may be turned into a virtually enabled space in which the environment is manipulatable by remote users. This creates an exciting and dynamic environment which consistently morphs into something new for the remote user. Bringing people together for online events in which users have instant connection with artists and each other to create a completely unique scenario and experience.

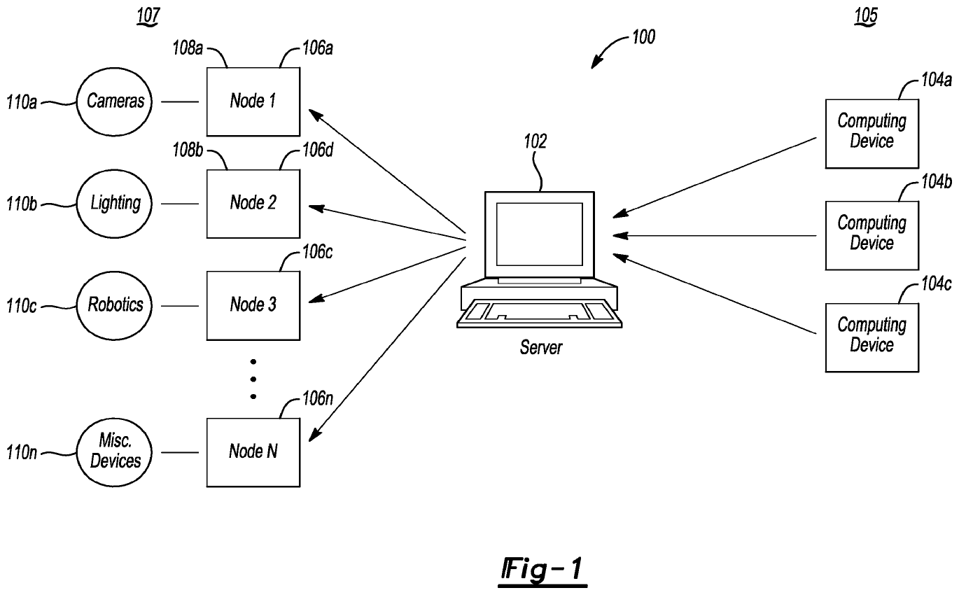

FIG. 1 depicts a system 100 for creating and managing a virtually enabled studio or live performance in accordance with an embodiment. The system 100 generally includes at least one server (hereafter “server) 102 that is operably coupled to a plurality of computing devices (or clients) 104a-104c. The computing device 104a-104n (or computing device 104) may include any one of a laptop, desktop computer, mobile device (e.g., cell phone, tablet), etc., that are under the control of various users. It is recognized that one or more of the computing devices 104a-104b may also be positioned in a vehicle 105 that displays the live performance on a display of the vehicle. The vehicle 105 may be an autonomous vehicle and may include a large display for enabling passengers to capture the live performance remotely away from a venue 107 in which live or studio performances are performed by, for example, musicians. Similarly, the one or more computing devices 104a-104b may be positioned in a living room of a residence or other establishment to enable smaller gatherings to view the live performance via a large display or screen. The system 100 also includes a plurality of nodes 106a-106n positioned in the venue 107. It is recognized that the live performance as indicated herein may also correspond to musicals, theatrical events, etc. In one example, the node 106a may correspond to at least one camera controller 108a (hereafter camera controller 108a) that controls various cameras 110a in the venue 107. In another example, the node 106b may correspond to at least one lighting controller 108b (hereafter lighting controller 108b) that controls various lighting 110b in the venue 107. In another example, the node 106c may correspond to at least one robotic (or prop) controller 108c (hereafter robotic controller 106c) that controls various props or other devices that mechanically move during the live or studio performance.

The users and their various computing devices 104a-104c may be positioned remotely from the venue 107 and may control any number of aspects with the live or studio performance while musicians are performing in the venue 107. It is recognized that any number of the users may enter commands via user interfaces (not shown) positioned on their various computing devices 104a-104c to control any one or more of the nodes 110a-110n and the corresponding cameras 110a, lighting 110b, robotics 110c, and so on that are located at the venue 107 such that the live or studio performance provides customized performance aspects that are based on the user's preferences. An online portal such as, for example, Twitch® allows users to watch broadcasted live stream performances (or prerecorded video of performances). In one example, a user interface and data communication protocol (e.g., a live chat box) may be created to enable messages to be transmitted while the user watches the live performance on their respective computing device 104a-104c. Additionally, one or more encoders that are positioned at the venue 107 that encodes the video and the audio and transmits such encoded video and audio to a server. In turn, a cloud database (or hosting database) (or clouds, hosting controller, or streaming platforms) transmits or streams the encoded video and audio to the computing device(s) 104a-104c. Specifically, a user may enter one or more commands via the user interface positioned on any one or more of the computing devices 104a-104c which are transmitted to the server 102. In turn, the server 102 transmits the commands to the intended node 106a-106c which executes the desired operation while the live performance or studio performance is taking place. The various nodes 110a-110n may control one or more of lighting, miking, amplification, videography, projection, pyrotechnics, confetti cannons, robotics on the stage, audio clips playing in the venue, etc. while the live performance is taking place.

Aspects disclosed in connection with the system 100 may also provide that the computing devices 104a-104c may transmit commands to the server 102, and subsequently to the nodes 106a-106n in response to keywords that are entered into a live chat box (e.g., Internet Relay Chat (IRC)) via an online portal as presented on the computing devices 104a-140c. The server 102 and/or the nodes 106a-106n may translate the commands received by the computing devices 104a-104c into DMX, MaxMSP, High Definition Multimedia Interface (HDMI), Serial, etc. to trigger events during the live performance in the venue 107.

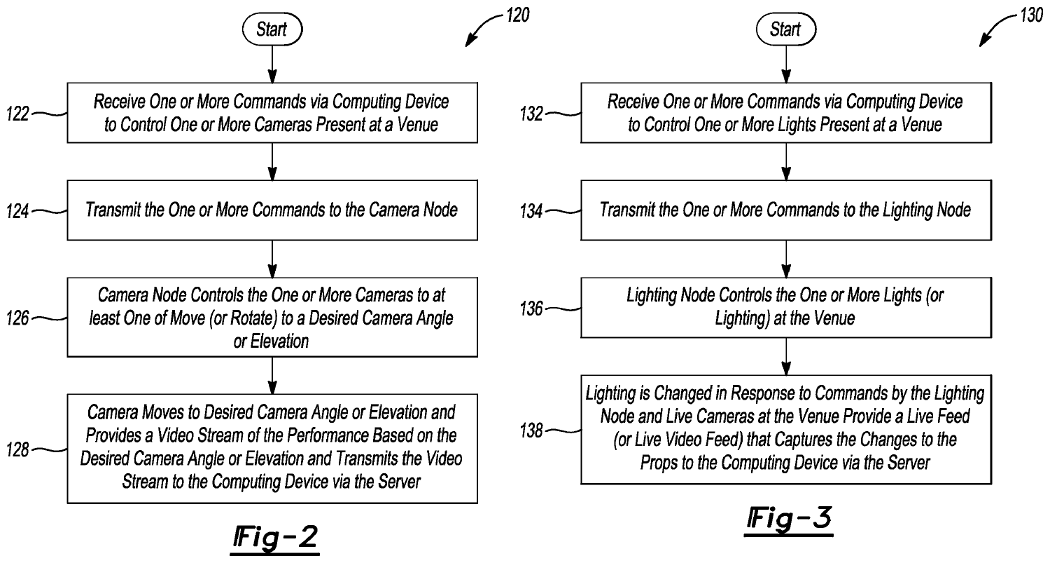

FIG. 2 depicts a method 120 for controlling one or more cameras 110a for the virtually enabled studio or for the live performance in accordance with one embodiment.

In operation 122, the computing device 104 receives one or more commands from a user (e.g., spectator) viewing the performance. One or more of the commands may correspond to requested movements of the camera 110a to provide the user a desired view of the performance. In another example, cameras 110a (e.g., GoPro® cameras) may be positioned on one or more members of the band (e.g., head/chest) performing in the live performance or on their respective musical instruments. The one or more commands may correspond to activating one or more of the cameras 110a positioned on any one or more of the live band members or on one or more of their musical instruments. The computing device 104 transmits the one or more commands to the server 102.

In operation 124, the server 102 transmits the one or more commands to the node 110a (or camera controller 108a) at the venue 107. The camera controller 108a is physically located in proximity to the venue 107 where the live performance is taking place.

In operation 126, the camera controller 108a controls the one or more cameras 110a at the venue to move (or rotate) to a desired camera angle or elevation to provide a live video stream of the performance in accordance with the one or more commands transmitted by the user. As stated above, the camera controller 108a may also selectively activate/deactivate any of the cameras positioned on the band member or on the musical instruments of the band members based on the commands received from the computing device 104. It is recognized that the server 102 provides a detailed listing or mapping of the location of the cameras 110a as dispersed in the venue 107 that captures the live performance and/or the location of the cameras 110a as positioned on any one or more of the band members or on one or more of their respective musical instruments. The server 102 provides this mapping (or camera map) to the computing devices 104 so that the computing device 104 enable the user to select any number of the cameras to control the operation thereof. It is recognized that the computing devices 104 may also provide the mapping for any of the features disclosed herein. The user may control any one or more the camera 110a to capture images of the live performance at a desired angle if requested by the user. For example, a user may control a camera closest to a singer to zoom in on the singer during the live performance. Similarly, in the even the user is a guitarist and is interested in obtaining a close up shot or view (e.g., zoomed view) of the guitar player on the stage while performing a guitar solo, the user may control the camera 110a closest to the guitarist (or on the guitarist or the guitar itself) to zoom in on the guitarist's fret board to get a close look at the guitarist while performing the solo. Additionally, other cameras 110a may be positioned about the venue to capture images of the entire band. The use may command such camera(s) 110a to zoom in or out to capture close ups of the entire band while they perform. Similarly, any one or more the cameras 110a (or omni-directional cameras) may provide a 360-degree view (e.g., birds-eye view) of the live performance if requested by the user. It is recognized that the camera controller 108 may transmit any number of video streams. In one example, the camera controller 108 may transmit a video stream for each musician performing at the venue 107 to the computing devices 104. In this regard, the computing devices 104 may also enable the user to select which of the video stream(s) to display.

In operation 128, the camera controller 108a may transmit captured images of the live performance in accordance with the desired angles or zoomed in or zoomed out shots as originally set forth in operation 122 to the server 102. In turn, the server 102 transmits the captured images back to computing device 104 to display for the user.

FIG. 3 depicts a method 130 for controlling lighting 110b in the virtually enabled studio or for the live performance in accordance with one embodiment.

In operation 132, the computing device 104 receives one or more commands from a user (e.g., spectator) viewing the performance. One or more of the commands may correspond to requested movements of the lighting to provide the user with a desired lighting of the performance. The computing device 104 transmits the one or more commands to the server 102.

In operation 134, the server 102 transmits the one or more commands to the node 110b (or lighting controller 108b) at the venue 107. The lighting controller 108b is physically located in proximity to the venue 107 where the live performance is taking place.

In operation 136, the lighting controller 108b controls any lighting at the venue 107 such as one or more of spotlights, strobes, light patterns, lighting in the audience at the venue 107, stage colors, animations etc. in the desired manner while the live performance is taking place (or in real time). In particular, the lighting controller 108b translates the messages (or commands) received from the computing device 104 via the server 102 into a Digital Multiplex (DMX) communication (or other suitable customized communication protocol) that controls the foregoing lighting devices and operations.

It is recognized that the server 102 provides a detailed listing or mapping of all of the lighting 110b as dispersed throughout the venue 107 that captures the live performance. The server 102 provides this mapping (or a lighting a map) to the computing devices 104 so that the computing device 104 enables the user to select any number of the lights (or lighting) to control the operation thereof. It is recognized that the computing device 104 may alternatively provide the detailed listing or mapping.

In operation 138, the lighting controller 108b controls the lighting 110b accordingly and the camera 110a via the camera controller 108a transmits captured images of the lighting 110b being controlled at the venue 107 of the live performance in accordance with the desired lighting as originally set forth in operation 132 to the server 102. In turn, the server 102 transmits the captured images back to computing device 104 to display for the user.

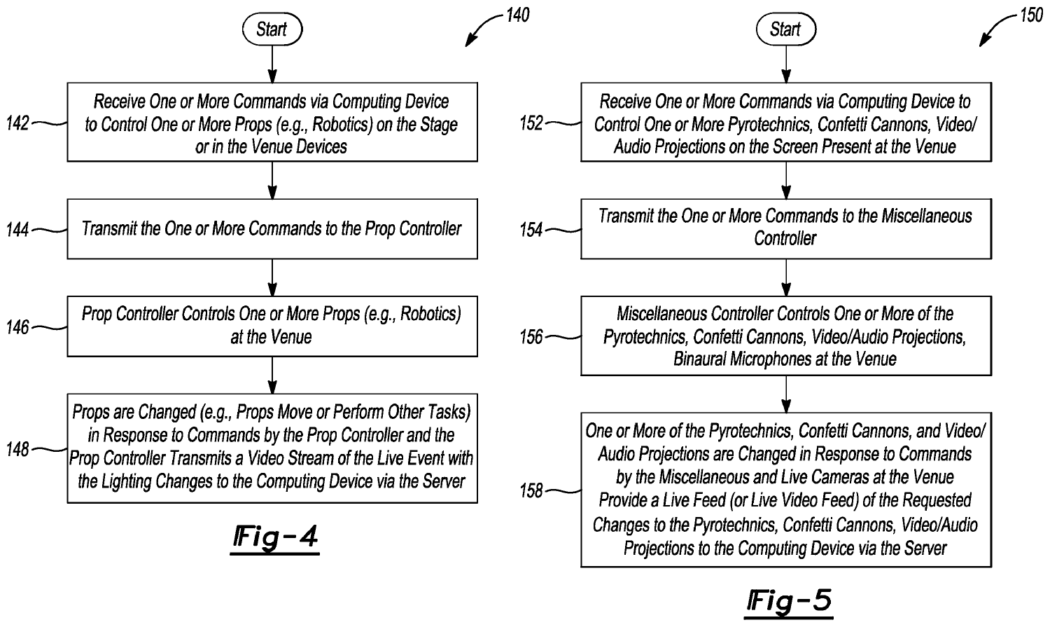

FIG. 4 depicts a method 140 for controlling one or more props (or robotics 110c) for a virtually enabled studio or for a live performance in accordance with one embodiment.

In operation 142, the computing device 104 receives one or more commands from a user (e.g., spectator) viewing the performance. One or more of the commands may correspond to requested movements of the robotics (or prop) to provide the user with a desired actuation of the prop(s) during the performance. The computing device 104 transmits the one or more commands to the server 102. In one example, the user may enter a command into the one or more of the computing devices 104a, 104b. 104c that may control the robotics node 106c to control any one or more of props (or robotics 110c) on the stage that are controlled electrically and that require mechanical movement or actuation in the desired manner while the live performance is taking place (or in real time).

In operation 144, the server 102 transmits the one or more commands to the node 108c (or the robotic controller 106c) at the venue 107. The robotic controller 106c is physically located in proximity to the venue 107 where the live performance is taking place.

In operation 146, the robotic controller 106c may activate/deactivate the desired props 110c at the venue in accordance with the one or more commands received from the computing devices 104 via the server 102. The node 106c translates the messages received from the server 102 into a communication protocol (or other suitable customized communication protocol) that controls the foregoing robotics/prop operations. The props may correspond to mechanical devices (or robots) that are positioned about or on the stage that artists may employ in enhancing the concert experience for its users. For example, consider the heavy metal band, Iron Maiden®, such a band has a mascot that is also known as “Eddie” or “Eddie the Head”: in which large mechanical robots are constructed in the form of Eddie on stage. The robot that is formed in the image of Eddie is known to appear on stage with the band and move about the stage while the band performs various songs. In this case, the user may elect to control various movements of Eddie via commands entered into the computing device 104a-104c that are sent to the robotics controller 106c via the server 102. In this instance, the node 106c may convert the commands as received by the server 102 into Serial data to control the movement of Eddie on stage during the live performance.

It is recognized that the server 102 provides a detailed listing or mapping of all of the props 110c as dispersed throughout the venue 107 that may be controlled during the live performance to the user. The server 102 provides this mapping (or a prop map) to the computing devices 104 so that the computing device 104 enables the user to select any number of the props to control the operation thereof. It is also recognized that the computing device 104 may also provide a detailed listing of the mapping of all of the props 110c.

In operation 148, the robotics controller 106c controls the props accordingly and the cameras 110a via the camera controller 108a transmits captured image of the props being modified based on the commands to the server 102. In turn, the server 102 transmits the captured images back to computing device 104 to display for the user.

FIG. 5 depicts a method 150 for controlling miscellaneous activities for a virtually enabled studio or for a live performance in accordance with one embodiment.

In operation 152, the computing device 104 receives one or more commands from a user (e.g., spectator) viewing the performance. One or more of the commands may correspond to controlling various items (or miscellaneous items 110n) on stage such as pyrotechnics, confetti cannons, video/audio projections on screen, miking, amplification, etc. in the desired manner while the live performance is taking place (or in real time). The computing device 104 transmits the one or more commands to the server 102. In one example, the user may enter a command into the one or more of the computing devices 104a, 104b, 104c that may control the miscellaneous controller 106n (e.g., pyrotechnics node, confetti cannon node, any number of displays at the venue 107 such as a video/audio projector, television, panel of LEDs (or a LEDs wall), etc.), miking node (e.g., microphones such as but not limited to binaural microphone(s), amplification, etc.) in the desired manner while the live performance is taking place (or in real time). The user may controller any number of aspects (or audio properties) such as but not limited to changing the tone of a guitar or bass, increasing the volume of a particular instrument. It is recognized that the system 100 may automatically increase the volume for any given musical instrument in response to the user selecting a dedicated video stream for that musician playing the musical instrument. Similarly, the user may create their own musical mix based on the audio received from the venue 107 and add personalized audio preferences such as equalization, effects, compression, etc. It is recognized that the microphones such as but not limited to binaural microphones may be positioned in the venue 107 (e.g., positioned about the audience at the venue 107) such that the microphones capture the ambience and feel of the audience at the venue 107 and to allow the microphones to provide the captured ambience to the computing device 104 via the server 102 and the miscellaneous controller 106n. The computing device 104 may also transmit commands to selectively activate and deactivate one or more of the microphones at the venue 107. It is recognized that the microphones may correspond to binaural, beamforming, directional, X-Y, Office de Radiodiffusion Télévision Française (ORTF) miking/recording solutions, etc. or other suitable techniques.

In operation 154, the server 102 transmits the one or more commands to the node 108n (or a pyrotechnics controller, a confetti cannon controller, a video/audio projections controller, miking controller, amplification controller, etc., collectively referred to as a miscellaneous controller 106n) at the venue 107. The miscellaneous controller 106c is physically located in proximity to the venue 107 where the live performance is taking place.

In operation 156, the miscellaneous controller 106n may activate/deactivate miscellaneous items 110n (e.g., pyrotechnics, confetti cannon, video/audio projection, miking (or microphones (e.g., binaural microphones, etc.)), amplification, etc.) in accordance with the one or more commands received from the computing devices 104 via the server 102. For example, the miscellaneous controller 106n may activate the pyrotechnics, the confetti controller, the video/audio projection, miking and amplification. With respect to miking, the miscellaneous controller 106n may increase or decrease the level of miking with respect to the audio captured on stage. For example, the miscellaneous controller 106b may control the level of audio and in particular control the level for a particular instrument that is captured by one or microphones to correspond to a desired amount that is requested by the user. Similarly, the user may adjust the amount of amplification that is applied to any instrument that is being played in the venue 107. The user may also activate any video or audio projections on any screens or monitors at the venue. The miscellaneous controller 106n may also selectively activate/deactivate the binaural microphones positioned at the venue 107.

It is recognized that the server 102 provides a detailed listing or mapping of all of the miscellaneous items 110n that may be controlled during the live performance to the user. The server 102 provides this mapping (or a miscellaneous map) to the computing devices 104 so that the computing device 104 enables the user to select any number of the items (e.g., types of audio and/or video clips that can be activated or deactivated, confetti cannon, pyrotechnics, miking for instruments, binaural microphones, and amplification of instruments) on to control the operation thereof.

In operation 158, the miscellaneous controller 108n controls the miscellaneous items accordingly and the cameras 110a via the camera controller 108a transmits captured images of the miscellaneous items 106n being modified based on the commands to the server 102. In turn, the server 102 transmits the captured images back to computing device 104 to display for the user. It is recognized that a sound board may be positioned at the venue 107 and wirelessly transmit audio streams to the server 102. In turn, the server 102 transmits the audio stream to the computing devices 104. Thus, in this regard, any changes performed to the miking and/or to the amplification will be captured in the transmitted audio streams that are transmitted to the computing devices.

Additionally, it is recognized that users of the computing device 104a-104c may exchange currency to obtain credits to allow such users to control the various nodes 106a-106n to effectuate the desired event that occurs during the live performance. In this regards, user may use their respective computing devices 104a-104c for any one or more of the following: control and/or access t HiFi audio as provided by binaural microphone(s) positioned both in the audience or on the stage of the live performance, solos for audio of specific instruments for the band members in the live performance, additional video streams, a chance to interact with the artist, the sharing of the user's name and emoticons on the projection screen positioned behind the band, and special events that take place during the live performance.

The server 102 may attribute different levels of prestige based on the number of credits purchased or through some other arrangement. Virtual currency enables users to pay for access and to control different features (e.g., cameras 110a, lighting 110b, robotics 110c, miscellaneous items 110n) based upon prestige and virtual currency balance. Higher prestige settings associated with the users may provide such users with a higher priority to overrule commands that may contradict one another. For example, user 1 may be considered a “base player” or customer and user 2 may be considered a “premium player”. If user 1 transmits a command to control the movement of a robot 110c to move forward and user 2 transmits a command to control the movement of the robot 110d to move rearward, the server 102 determines that prestige level for each of user 1 and user 2 and activates the command (e.g., the command from user 2) to move the robot 110c to move rearward since the prestige level for user 2 is higher than that of user 1. Additionally, if two users share a similar prestige level, the server 102 may effectuate the desired event at the live performance in the venue 107 based on the sequential order in which the command is received relative to other commands. In this case, the server 102 may employ a time delay once an event is activated or deactivated to allow the desired event to occur during the live performance at the venue 107. Once the delay expires, the server 102 may then process the next command to allow the desired event to be activated or deactivated during the live performance at the venue 107. In addition to executing commands for users based on prestige or standing, the system 100 may alternatively monitor or aggregate a predetermined number of commands and execute such commands based on a simple majority in terms of what is being primarily requested by the users.

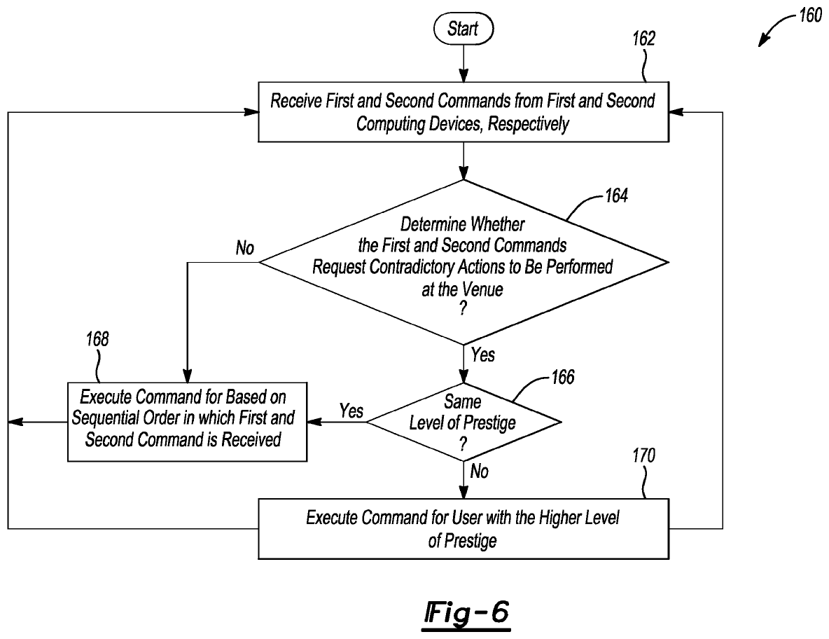

FIG. 6 depicts a method 160 for determining a prestige among a first user and a second user when contradictory commands are provided for controlling aspects related to the virtually enabled studio or live performance in accordance with an embodiment.

In operation 162, the server 102 receives first and second command from first and second computing devices 104a, 140b, respectively. In operation 164, the server 102 determines whether the first and second commands includes contradictory actions to be performed at the venue 107. For example, the server 102 may determine that the first command indicates a first lighting sequence that differs from a second lighting sequence that is requested via the second command. In the event there are no contradictory commands have been received, then the method 160 proceeds to operation 168 and the server 102 may then execute the two commands based on the sequential order in which the commands were received. In the event the server 102 determines that there are contradictory commands, then the method 160 moves to operation 166.

In operation 166, the server 102 assess or determines whether the first user and the second user has the same level of prestige. For example, in the event the first user and the second user has the same level of prestige, the server 102 needs to asses other criteria to determine whether to execute the first and the second commands as it is not preferable to execute changes in the venue 107 that are contradictory to one another at the same time. In the event the server 102 determines that the first user and the second user has the same level of prestige, then the method 160 proceeds to operation 168 and executes the commands based on the sequential order in which such commands were received. In the event the server 102 determines that the first user and the second user does not have the same level of prestige, then the method 160 proceeds to operation 170.

In operation 170, the server 102 transmits the command that was received first between the first and the second commands to the venue (or any one of the nodes 106a-106n) such that the command belonging to the user with the highest prestige level is executed first. Once the command belonging to the user with the highest level of prestige is executed at the venue 107, then the server 102 transmits the next command that is received belonging to the user with the lesser level of prestige so that this command is executed thereafter at the venue 107. In operation 170, the server 102 transmits the command belonging to the user with the highest prestige level to the venue 107 such that this command is executed.

A chat box (or other user interface medium) may be used at the computing devices 104a-104c to handle messaging, interpretation of the IRC and whether or not a user have access to the system 100 and then sends command via a DAC. The commands transmitted from the computing devices 104a-104c (e.g., the IRC) may be sent (directly or indirectly) to the nodes 108a-108n . This may be performed via a script, socket commands, DMX, serial, etc. Any use of a digital to analog converter (DAC) may be utilized to transmit voltage or current to trigger relays, robotics, etc. It is recognized that the IRC (or chat box) may transmit many types of analog or digital commands to a variety of nodes. Examples of digital commands types may include MIDI, Serial, DMX lighting controllers, TCP, etc., and examples of analog signals may include lighting, robotics, relays, meters etc. It is recognized that either digital or analog based signals may be transmitted in the system 100. It is further recognized that the nodes 108a-108n may be integrated into a single electronic unit that is configured to translate any number of the commands received by the server 102 into DMX, MaxMSP, HDMI, Serial, etc. Information in the DMX, MaxMSP, HDMI, Serial format may then be transmitted to the corresponding cameras 110a. lighting 110b, robotics 110c, and miscellaneous items 110n, etc. to control such devices in the manner requested at one or more of the computing devices 104a-104c.

In another example, the server 102 may determine the results of voting proxies that are submitted thereto from via the user interface (e.g., IRC) of the computing devices 104a-104c. Votes may be used to determine the next song, when to trigger a fog machine, (pyrotechnics, robotics, etc.), answer trivia, trigger another event, etc. Votes may also be interpreted as a meter or condition of whether or not to trigger an event). For example, a “vote meter” may be utilized where 500 people may vote to change lights in the live performance to red. At that point, once a threshold has been reached (or a majority of votes have been reached), the lights may be controlled to turn on red. The server 102 may also control remote computers (e.g., cellular phones, tablets, laptops (e.g., any internet connected device)) positioned anywhere within the venue 107 (e.g., on stage, front row, in the green room, backstage, front of the house, etc.) to host video calls with exclusive users in order to “Bring users on stage”.

In another example, the server 102 may enable group events that are hosted remotely for users to remotely log in to. Additionally, the computing devices 104a-104c provide for an exclusive interface for one-time events for users to: (1) press a button, (2) vote, (3) answer trivia questions, (4) draw an animation, (5) change stage colors, etc.

The system 100 generally enables live virtual concert series which will be streamed live online. The system 100 also enables fans to stream for free and also provide for tiered levels of access to features and audio quality of the live performance. The system 100 also provides tiered tickets to additional access to content and exclusive merchandise.

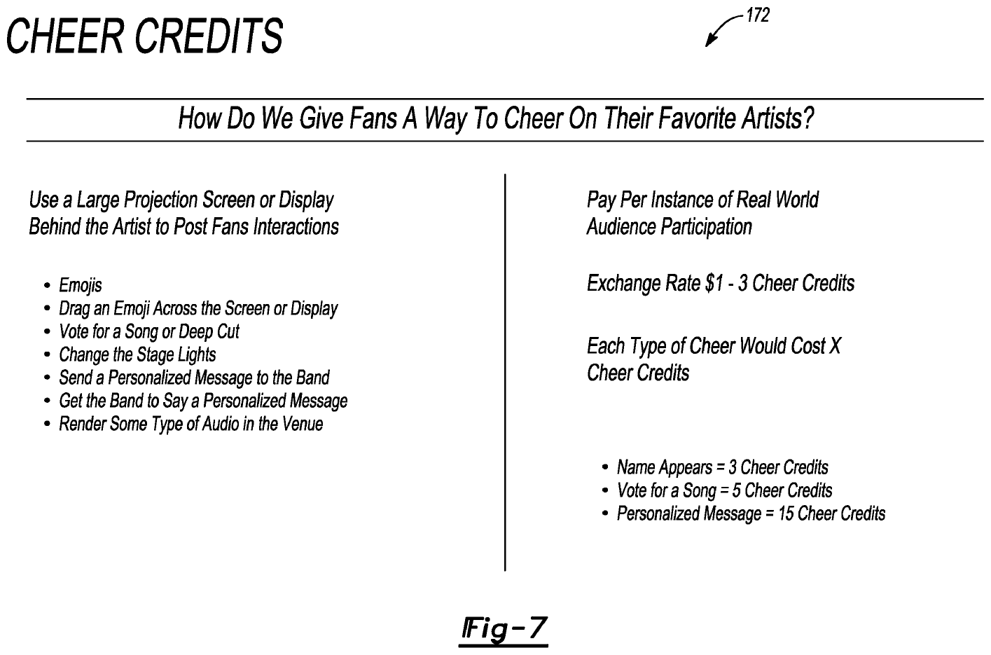

FIG. 7 depicts examples of cheer credits 172 that may be issued by the system 100 of FIG. 1 in accordance with one embodiment. FIG. 7 illustrates various cheer credits that may be issued to users when such users exchange currency for the credits. For example, the system 100 may enable user to use large projection screen(s) behind the artist to post various fan interactions such as emojis, to drag an emoji across the screen, to vote for a song or deep cut performed by the artist, to send a personalized message to the band that is displayed on the projection screen, to have one or more band members verbally say a personalized message during the performance, and/or to render some type of audio in the venue 107. FIG. 7 further depicts examples of currency that may be used for an exchange rate for the various cheer credits.

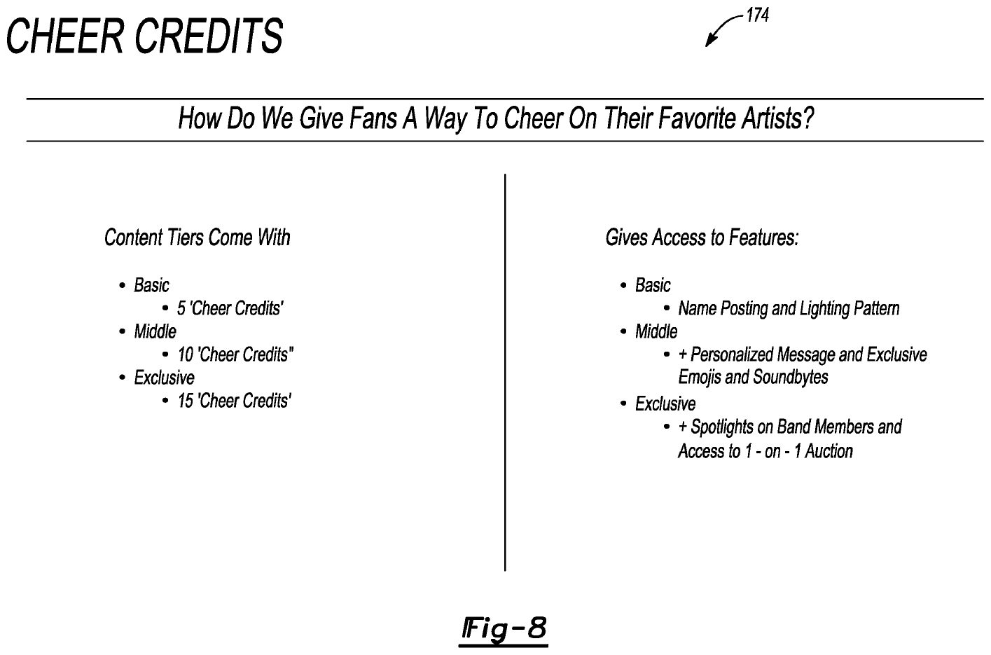

FIG. 8 also depicts examples of cheer credits 174 that may be issued by the system 100 of FIG. 1 in accordance with one embodiment. For example, the system 100 may provide content tiers that come with a predetermined number of cheer credits. In one example, the system 100 may provide a first level (or basic level) that provides 5 cheer credits, a second level (or middle level) that provides 10 cheer credits, and a third level (e.g., exclusive level) that provides 15 cheer credits. The first level may provide access to name posting (e.g., name of user of computing device) for publication or posting at the venue 107 during the live performance and a selected lighting pattern. The second level may provide a number of personalized messages and exclusive emojis or sound bytes. The third level may provide any number of spotlights on band members and access to join a one on one auction.

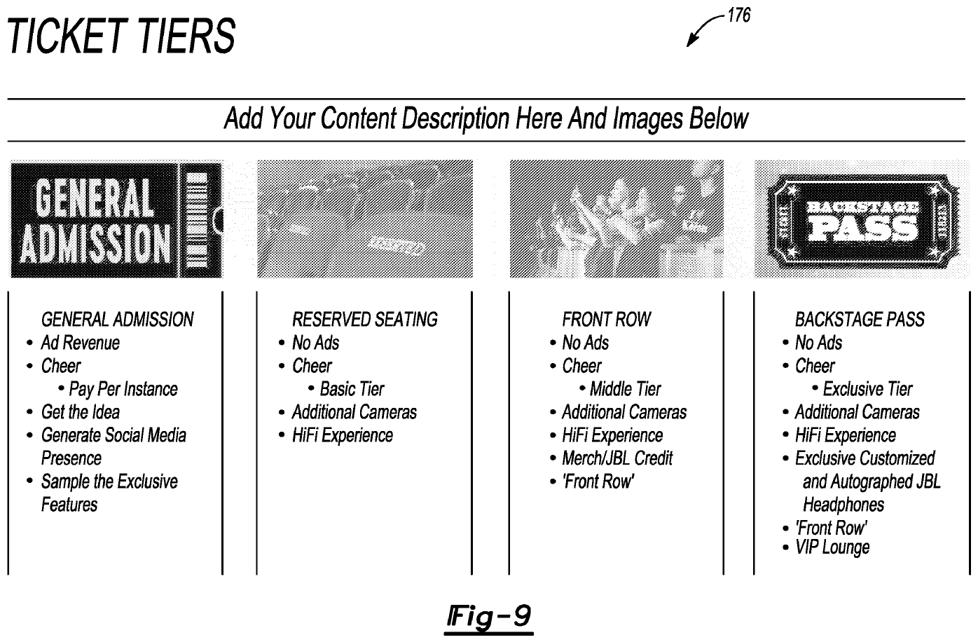

FIG. 9 depicts examples of ticket tiers 176 that may be issued by the system 100 of FIG. 1 in accordance with one embodiment. In general, the ticket tiers 176 may include general admission, reserved seating, front row seating, and a backstage pass. The general admission tier may provide advertisement to the users, cheers for purchase or cheers for inclusion free of charge, a pay per instance option, a “get the idea” option, and enable users the opportunity to sample exclusive features that may result in the user purchasing ticket for higher tiers. The get the idea option may correspond to providing a 30 or 60 second preview of upgrades that are available such as a HiFi audio experience or other suitable feature.

The reserved seating tier may provide a no advertisements feature for purchasers so that users/purchasers don't have to be exposed to advertisements during the show. The reserved seating tier may also provide cheers for purchase or cheer for inclusion free of charge and provide the purchaser with the option of activating/deactivating more cameras than that allowed in the general admission tier. The reserved seating tier may also provide purchasers a HiFi audio experience. Te HiFi audio experience may correspond to higher quality audio, lossless codecs, binaural processing (e.g., provides the perception that the user is actually in the audience based on the manner in which audio is reflected off of the walls in the venue 107).

The front row seating tier may also provide a no advertisement features along with cheers for purchase or for free as part of the package. Similarly, the front row seating tier may provide purchasers with a HiFi audio experience and front row like seating option. The front row like seating option generally includes the system 100 providing a raffle in which a random fan will be selected to have a one-to-one experience with a band member the concert. The front row seating tier may also provide option to purchase merchandise and credit for headphones with head tracking options (e.g., an audio experience as provided by the JBL QuantumSPHERE 30 360®) for an enhanced audio experience. The backstage pass tier may provide, when purchased, a no advertisement features along with cheers for purchase or for free as part of the package. Similarly, the backstage pass tier may provide purchasers with a HiFi audio experience and more control over a greater number of cameras 110a in the venue 107 than that offered by the other tiers. The backstage pass tier may also provide for users to receive an exclusive customized and autographed head tracking system, such as for example, an autographed JBL headphones. The backstage pass also includes the front row seating experience option and VIP lounge. The VIP lounge feature as offered by the system 100 enable fans with access thereto to appear on mobile devices (e.g., tablets) that are positioned in the green room of the venue 107 which allows users the ability to hear what band members are discussing and also the ability to talk to band members before or after a show.

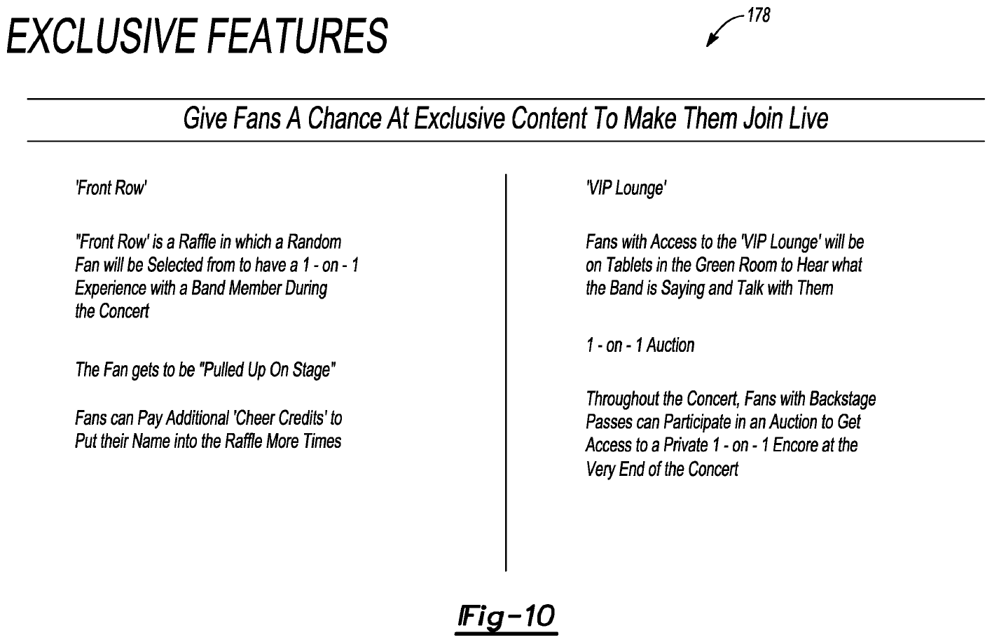

FIG. 10 depicts examples of exclusive features 178 that may be issued by the system 100 of FIG. 1 in accordance with one embodiment. The exclusive features 178 offered by the system 100 include the front row option and the VIP lounge option as discussed above. The front row option enables the user to be “pulled up” on stage and the front row option enables fans to pay an for additional cheers. Similarly, with the front row option, the user can enter their name into the raffle as often as desired. The exclusive features 178 also provides an “1-on-1 option” in which fans with the backstage pass tier can participate in an auction to get access to a private one on one encore the band members at the very end of the live performance.

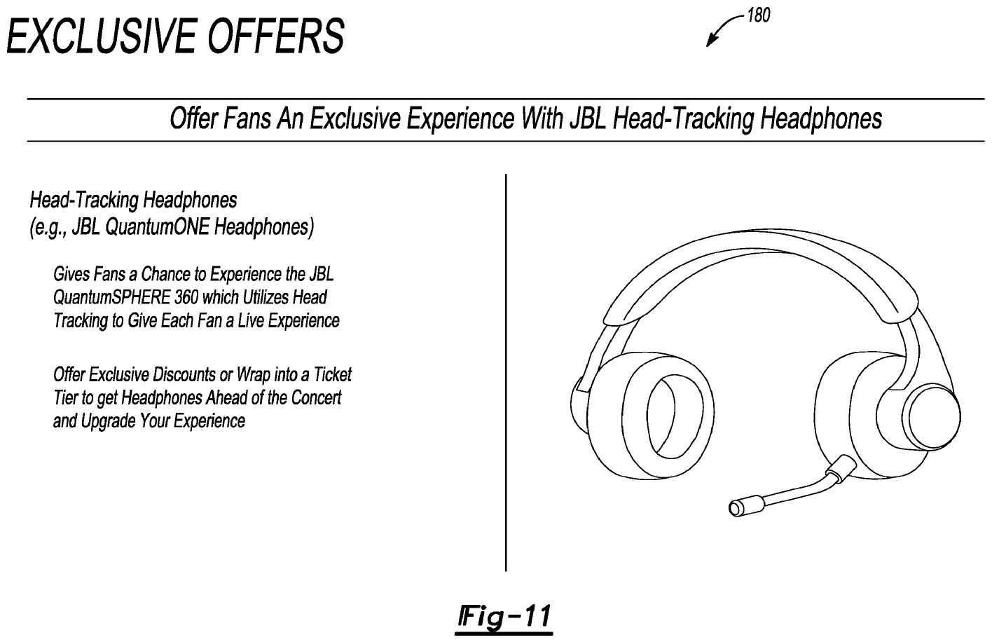

FIG. 11 depicts examples of an exclusive offer 178 that may be issued by the system of FIG. 1 in accordance with one embodiment. As noted above, the exclusive offer 178 may correspond to head-tracking based headphones (or headphone system) such as, for example, the JBL QuantumONE® headphones. The system 100 enables user the opportunity to utilize head tracking to provide the user with a live experience.

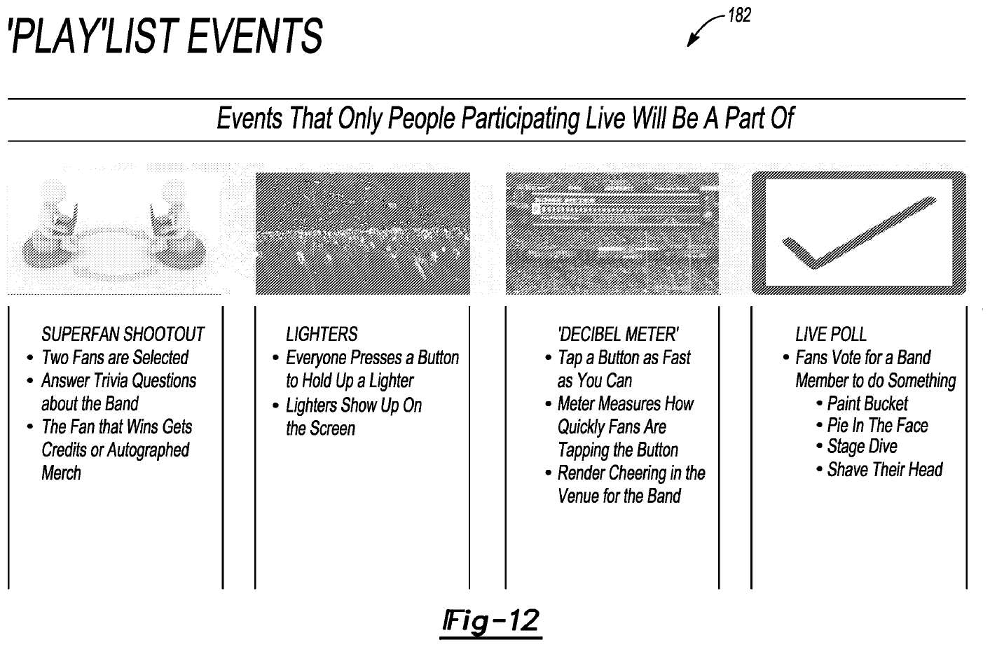

FIG. 12 depicts examples of playlist events 180 that may be issued by the system 100 of FIG. 1 in accordance with one embodiment. The playlist events 180 may only be available to events that people participating live at the venue 207 will be part of. For example, the playlist events 180 includes a superfan shootout, lighters, decibel meter, and a live poll. The “superfan shoot out” involves two or more fans being selected whereby such fans answer trivia questions about the band. Also, the fan that wins, for example, the trivia contest is provided with credits or autographed merchandise. The “lighters event” corresponds to users participating via their respective mobile devices to select a prompt on a user interface of their respective computing device to hold up a lighter. Thus, the lighters show up on the screen. The “decibel meter event” allows users, via computing devices 104, to tap a button or prompt on their screen (or user interface) as fast as possible and a meter positioned at the server 102 or at any one of the nodes at the venue 107 measures how quickly fans are tapping such a button. The tapping on the computing devices 104 is converted by the computing devices 104 or the server 102 into cheering for playback also at the computing devices 104. The “live poll event” enables fans (or users) to vote for a band member to perform a particular act. Such acts may correspond to having the band member tip over a paint bucket over their head, compel the performing to splash a pie in his/her face, stage dive into the audience, and/or shave their head, etc.

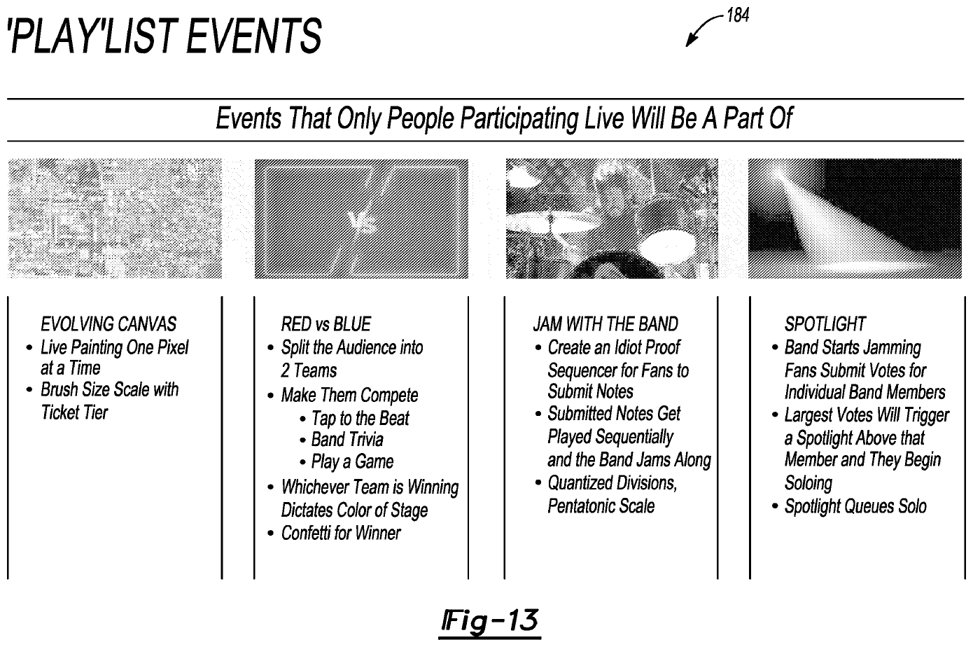

FIG. 13 depicts examples of additional playlist events 182 that may be issued by the system 100 of FIG. 1 in accordance with one embodiment. For example, the additional playlist events 182 include an evolving canvas event, a red vs. blue event, a jam with the band event, and a spotlight event. The evolving canvas event includes live painting one pixel at a time that is performed via the computing device 104 which is then presented on a projection screen at the venue 107. This also involves a brush size scale with ticket tier. The red vs. blue event includes splitting the users on their respective computing devices 104 into two or more teams in which such users compete against one another by tapping to the beat on their computing device 104, playing band trivia, or playing a game. Whichever team wins dictates a virtual color of the stage with is then presented to the computing device 104 for viewing. The jam with the band event includes creating an idiot proof sequencer for fans to electronically submit notes (e.g., musical notes) via computing devices 104. The submitted notes gets played sequentially by the band on stage and the band plays along. The musical notes may be in quantized divisions and in a pentatonic scale.

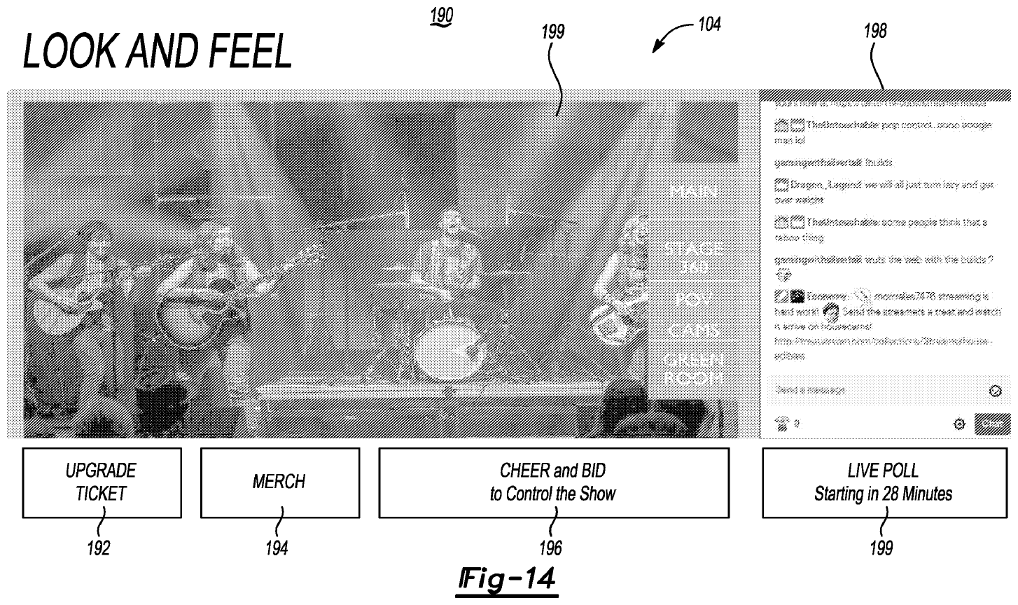

FIG. 14 depicts an illustrative user interface 190 on the computing device 104 of the system 100 of FIG. 1 in accordance with one embodiment. The user interface 190 may provide an upgrade ticket field 192, a purchase of merchandise field 194, a cheer and bid field 196, and a dialogue box 198. The user can upgrade his/her ticket tier by selecting the upgrade ticket field 192 to upgrade to an one of the reserved seating tier, the front row tier, or the backstage pass as generally shown at 176 in FIG. 9. The user may purchase merchandise associated with the band via the merchandise field 194. The user may also cheer and bid via the cheer and bid field 196 to control aspects of the show. The dialogue box 198 enable the user to post/comment along with other users who are virtually viewing the event. It is recognized that any reference to inputting or selecting option(s) via the computing device 104 as set forth herein also involves the transmission of such data to the server 102 and to the nodes 106 positioned at the venue 107.

### A System and Method for Remotely Creating an Audio/Video Mix and Master of Live Audio and Video Streams

Current live streams of audio and videos or for any television-based show is a pre-designed mix and edit from professionals. This may be particularly useful for items like television where a specific experience is desired. However, for a live or pre-recorded event or even a day-to-day stream where multiple audio and video sources are available, it may be desirable for a user to create their own experience and to have access to all cameras that are present in the live performance and to all audio streams along with other content. This may solve the issue of every video and audio stream being pre-packaged and be turned into an individualized experience every time.

Aspects disclosed herein generally enable users to access and create/edit different content from an event to create their own unique experience. Users that operate computing devices may have access to multiple raw content streams (e.g., audio and video streams) coming from a live or prerecorded event. It is recognized that the content streams may be extended outside of audio and video. The server may provide the content streams to remote, end users (e.g., computing devices (or clients) via existing platforms such as, but not limited to: YouTube®, Twitch®, Vimeo®, Spotify®, etc. and accessing these streams via the computing devices or clients. The platform may also include one or more encoders that are positioned at the venue 207 that encodes the video and the audio and transmits such encoded video and audio to a server. In turn, a cloud database (or hosting database) (or clouds, hosting, or streaming platforms) transmits or streams the encoded video and audio to the computing device(s).

The embodiments disclosed herein introduces the difficulty of time aligning each content stream with one another so that there is no delay. It could also be implemented by running a main instance on a server in the location of the event as well as a remote, end user instance which users could install to give them access to all the features. The computing device (or a server) may enable users to create and mix their own experience by editing and processing raw streams from the event. Similarly, the user may create their own musical mix based on the audio received from the venue 107 and add personalized audio preferences such as equalization, effects, compression, etc. The server (or alternatively a sound board or a video board) may execute instructions in the venue where a live performance or studio performance takes place. The users may be able to enable/disable settings that are being applied and which content streams have been selected at different times throughout the event which is recorded in real time and put into a master recording at the end.

Users may also be able to select which “picture-in-picture” stream they want to be shown in tandem with the main selected stream. For example, if the event is a live streamed concert, while the guitarist solos, the users may select “a guitar camera stream” and “a solo the guitar only audio stream”. The users may also select a “drummer stream” to be in a smaller “picture-in-picture” and add a portion of the drummer's audio into the drummer stream. As soon as the solo is over, the user may then select the main camera stream and switch the audio back to all instruments. This may occur in real time with no delay between the switching of content however, it may not affect any other user's concert experience as all settings and selections only affect the local instance of this software that is executed. The entire experience may be recorded in real time and inserted into a master recording at the end. The users may also re-watch the audio/video mix to experience the event in the manner they desire. It is recognized that users may go back at a later date to re-mix and master the experience for a completely unique experience.

With the server being at the location of the event, the server may stream multiple different streams of content including, but not limited to, audio and video directly to the user's computing devices. These streams may come directly from hardware located in the venue (e.g., sound board, video booth, etc.) enabling user access to all content streams being supported and supplied to the venue. The server may also be input with the current settings that are utilized in the streaming location (e.g., sound mix, audio/video processing settings) which have been chosen and designed by the artists, engineers, or streamer, etc. at the location.

The computing devices associated with the users may access multiple streams of different content from existing streaming sites (e.g., YouTube®, Vimeo®, Twitch®, Spotify®, Pandora®, Soundcloud®, Tidal®, etc.) using things similar but not limited to: embedded Uniform Resource Locator (“URL”), Application Programming Interfaces (APIs), etc. Such an implementation may load each content stream concurrently into software. When the user selects a different content, the computing device may either hide or unhide the designated content stream and the previous content stream to reflect the user's command. A delay and delay offset may be determined to align each content stream and to ensure there is no delay when the user switches between content stream.

Both implementations of the software approach may enable users to trigger events via buttons that may interface with the live events, multiple different functionalities and real time outputs in the venue or location of the event. This may be implemented by sending commands via the server located in the event or via URL of the associated stream and similar to, but not limited to: socket commands, internet relay chart (IRC), chatbot, etc. The method of triggering commands may be constrained by the manner in which triggers are set up in the event space, not by the computing device.

The users may have a main interface screen on their respective computing device that illustrates their personally designed experience. The computing device belonging to the user may also include submenus or different tabs that provides an additional interface to adjust settings for each content stream to create a mix of different content and the manner in which the users create such mixes. For example, an audio page may have a similar interface to a mixing board that includes knobs, faders, sliders to adjust a microphone or instrument (e.g., wet/dry mix, overall gain, channel gain, mute/unmute, solo, etc.). A video page may provide previews of every camera angle to choose from, video processing tools including filters, contrast, exposure, tint, saturation, etc. For example, the users may select multiple video streams to be overlaid via primary video page with picture-in-picture of another camera in the corner, split screen with two video streams, etc. At any time, end users may have the ability to change back any of the settings to the current settings being designed in the venue but the streamer, artist, or engineers, etc. This may be controlled to ensure that certain users don't accidentally destroy their experience. Various limits with respect to the amount users who can control to the stream or the amount of changes that they may perform to EQ, wet/dry mix., overall gain, video tints, etc. may be imposed by the server to provide improved ease of use for end users.

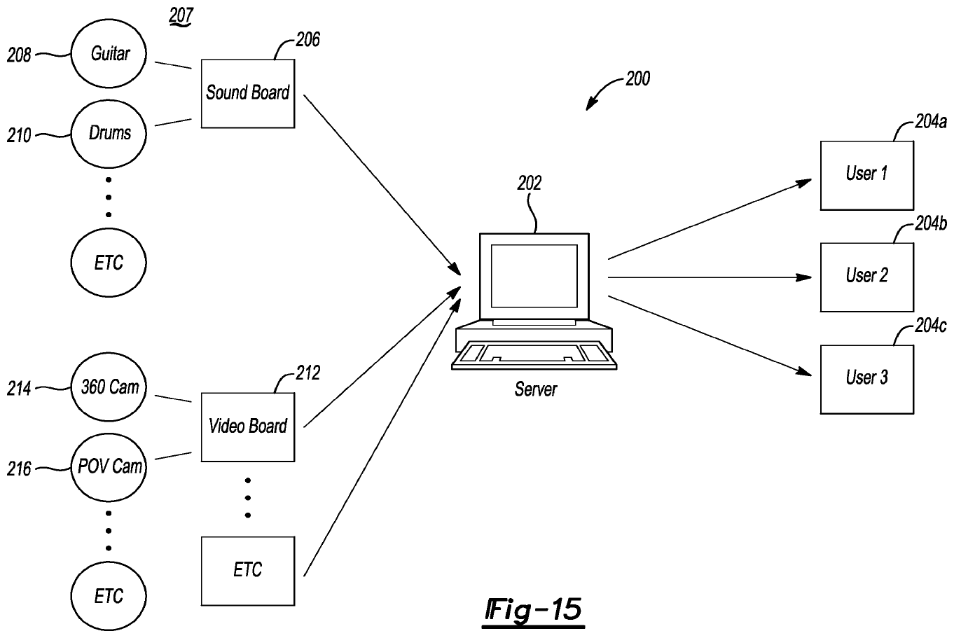

FIG. 15 depicts a system 200 for remotely creating an audio/video mix and master of live audio and video streams in accordance with an embodiment. The system 200 generally includes at least one server (hereafter “server) 202 that is operably coupled to a plurality of computing devices (or clients) 204a-204c. The computing devices 204a-204n (or computing device 204) may include any one of a laptop, desktop computer, mobile device (e.g., cell phone, tablet), etc. that are under the control of various users. The system 200 also includes a sound board 206 positioned in a venue 207 where live or studio performances are performed by, for example, musicians.

At least one guitar 208 and drums 210 are operably coupled to the sound board 206. It is recognized that any number of musical instruments (e.g., bass guitar, keyboard, vocal input, etc.) may be operably coupled to the sound board 206. The sound board 206 is generally configured to receive various tracks or streams (e.g., guitar stream, bass guitar stream, vocal streams, drum stream, keyboard stream, etc.) from the various instruments 208, 210 and transmit such streams to the server 202 (e.g., wirelessly or via hardwired direct connection).

A video board 212 is operably coupled to the server 202. The sound board 206 and the video board 212 may both be referred to as a media controller. A 360 field of view (FOV) camera 214 (or omni-directional camera) is operably coupled to the video board 212. Similarly, a point of view (POV) camera 216 is operably coupled to the video board 212. The POV camera 216 provides a captured image of a musician or performer (or close up image of the musician or performer). It is recognized that any number of cameras may be operably coupled to the video board 212 along with the streams of video from the FOV camera 214 and the POV camera 216. It is also recognized that the server 202 may be positioned somewhere in the vicinity of the venue 207. The server 202 may then transmit the various audio streams received from the sound board 206 and video streams received from the video board 212 to the computing devices 204a-204c associated with the users. The audio and video streams may be streamed from the server 202 to the computing devices 204a-204c via YouTube®, Vimeo®, Spotify®, etc. In general, by being the originator of the stream as well as the algorithm (e.g., software and hardware) that the users utilize on their computing devices 204a-204c, this aspect enables the system 200 to determine the delay between the streams and adjust such a delay appropriately to create a seamless and lag-free experience for the user. Generally speaking, all the audio/video streams are already synchronized at the server 202 which is located at the live venue 207 with the artists/musicians/performers. These time-aligned streams are then distributed to the viewers via the streaming platforms such as, for example, YouTube®, Vimeo®, etc. Therefore, complexity may be reduced and there may not be any latency issues for any users.

With the computing devices 204a-204c, users may be able to modify, enable, disable etc. all settings that are currently set on the audio and video streams as received from the venue 207. In addition, the user may be able to modify, enable, disable, etc. all settings that are set on the audio and video streams at different times throughout the live performance which is recorded in real time. Additionally, the sound board 206 and/or the video board 212 may also store all audio settings (e.g., guitar, bass, vocal settings, etc.) in addition to all video settings (or camera settings) while the live performance is being performed and provide such information to one or more of the computing devices 204a-204c via the server 202. The users, via the computing device 204a-204c, may adjust the settings which would have been selected by the artists, sound engineers, or streamers at the venue 207 while the live performance occurred. The users may also be able to adjust and change the audio settings in the venue 207 in which the location of the live performance takes place. Similarly, the users may also be able to adjust and change the video settings in the venue 207 in which the location of the of the live performance takes place. The users of the computing devices 204a-204c may record the modified or adjusted video and audio streams (with or without adjusted audio and video settings) and play back the recorded modified or adjusted video and audio stream. It is recognized that the computing devices 204a-204c may continue to allow the user to adjust/modify the audio and video streams any number of times.

As noted above, the computing devices 204a-204c may stream the audio and video streams via YouTube®, Vimeo®, Twitch®, Spotify®, Pandora®, Soundcloud®, Tidal®, etc.). This approach may load each content stream concurrently while the live performance takes place at the venue 207. When the user selects a different media content at the computing device 204a-204c to either hide or unhide the designated or select content stream and the previous content stream to reflect the user's command.

Users may also select, via any one or more of the computing devices 204a-204c, a “picture-in-picture” stream that the user may desire to be shown in tandem with the main selected stream on a display of the computing device 204. For example, the event is a live streamed concert, while the guitarist solos, the users may select “a guitar camera stream” and “a solo guitar only audio stream” via the computing device 204. The user may also select, via the computing device 204, a “picture-in-picture” option and add a portion of the drummer's audio into the stream as the guitarist plays along. As soon as the solo is over, the user may select, via the computing device 204, a main camera stream and switch the audio back to all instruments. This aspect may occur in real time with no delay between switching of content. Additionally, this may not affect anyone else's concert experience as all settings and selections only affect the local instance on the computing device 204 that modifies the audio and/or video stream.

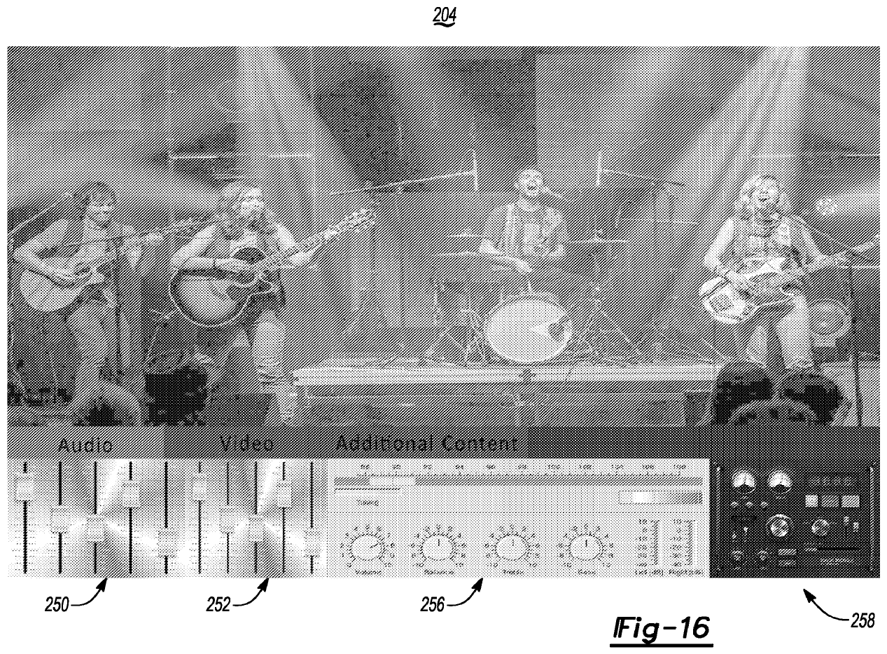

The computing devices 204a-204c may each include a main interface screen which illustrates personally designed experience. In submenus or different tabs on a user interface of the computing device 204, the computing device 204 may provide an additional interface to adjust settings of each different content stream (e.g., guitar stream, bass stream, drum stream, video stream, etc.) to create a mix of different content. For example, the computing device 204 may provide an audio page 250 (see FIG. 16) may provide a similar interface to a mixing board. The audio page 250 generally includes knobs, faders, sliders to adjust mic/instrument eq, wet/dry mix, overall gain, channel gain, mute/unmute, solo, etc. An additional content page (or tuning page) 256 includes control switches (or knobs, sliders, etc.) for controlling volume, balance, treble, and bass for the received audio stream. An editing field 258 enables users the ability to create or edit audio streams or tracks for each dedicated musical instrument. For example, the editing field 258 displays knobs and faders that may be manipulated via user input where each fader is tied to a corresponding musical instrument (e.g., guitar, bass, vocals, drums, keyboard, etc.). The editing field 258 allows user the ability to mix various tracks of audio and operates as a mixing desk and also provides the user with the ability to balance the audio.

In addition, the computing device 204 may include a video page 252 that may be provided or displayed to a plurality of small previews of every camera angle that is available for the user to select from the computing device 204. The computing device 204, via the video page 252, may also provide video processing tools including filters, contrast, exposure, tint, saturation, etc. Additionally, the user may select via the computing device 204 multiple video streams to be overlayed. The computing device 204 may also provide a picture-in-picture of another camera in the corner, split screen with 2 video streams, etc. At any time, the users, via the computing device 204, may have the ability to change back any of the settings to the current settings that are actually applied to the live performance by the artist, engineer, or streamer. The computing device 204 may be configured to ensure that particular users don't accidentally destroy their experience. In one embodiment, it may be preferable to set limits to the number of changes to the setting to avoid destroying the experience of the streams as a user may go too far with many aspects of the settings such as EQ, reverb, gain, etc. Such drastic changes to these settings may not make the experience enjoyable for the user. The computing device 204 may be configured to limit the amount of control or limit the amount the EQ, wet/dry mix, overall gain, video tints, etc. that can be performed on the streams provided by the server 202 to provide an improved ease of use for end users.

Aspects disclosed in connection with the system 200 provide, but not limited to, (i) control over camera angles and stream of the live performance in addition to control the audio stream and the type of broadcast on the audio stream, (ii) provide a user interface on the computing devices 204a-204c that includes, for example, sliders and/or other switching mechanisms for a number of controls (e.g., level control for each instrument, EQ changes, wet/dry mix, etc.), (iii) an end user configurable platform on the computing devices 204a-204c that enables users to mix audio and to select the corresponding video stream from the video board 202., (iv) reset to a default “Front of House” mix from the audio engineer at the venue 207, (v) select the desired video stream for a large selection of a plurality of video streams of the live performance, (vi) provide picture-in-picture with other video streams from the live performance, (vii) enable users to record their own concert mix (e.g., video/audio) of the live performance and remix it later, (viii) stream multi-channel content, multiple audio streams comprising different streams of different instruments, and (ix) stream multi-channel content, multiple audio streams, and multiple video streams.

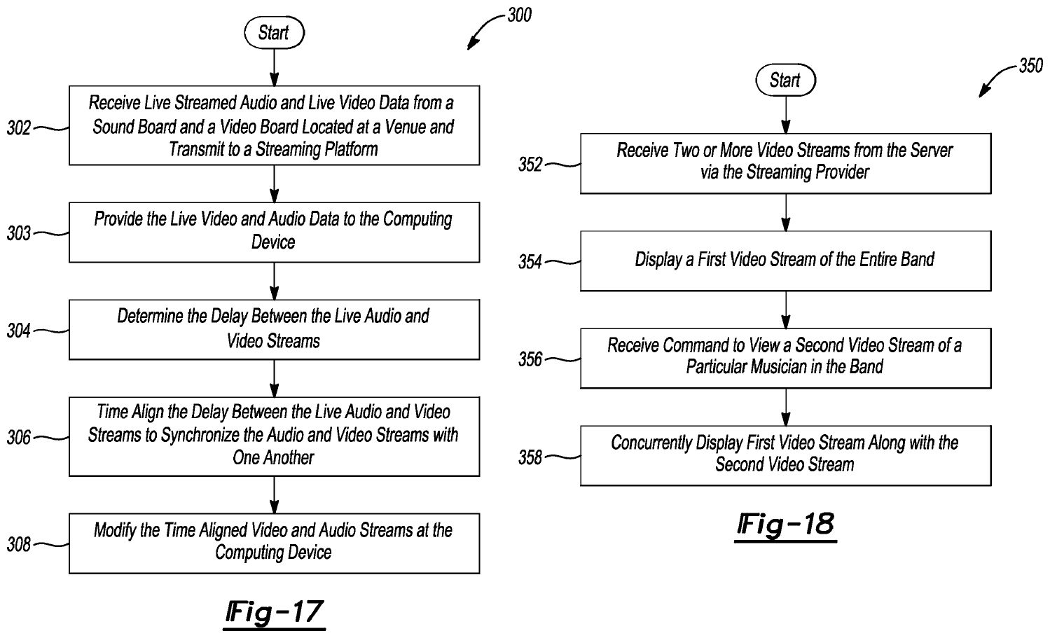

FIG. 17 depicts a method 300 for time aligning audio and video streams from a live performance in accordance with one embodiment.

In operation 302, the server 202 receives live streamed audio and video data from the sound board 206 and the video board 212, respectively, (or from the media controller) positioned at the venue 207. It is recognized that the video streams may include a number of video streams captured from the various cameras 214 and 216 that are positioned at the venue 207. For example, assuming a band is performing live at the venue, the various cameras 214 may provide a first video stream that captures the entire band and the cameras 216 may provide (or point of view shots) additional video streams for each individual band member. Likewise, it is recognized that the audio stream may include any number of audio streams captured from the various instruments 208, 210 that are positioned at the venue.

In operation 303, the server 202 transmits the live streamed audio and video streams to a streaming platform (e.g., YouTube®, Vimeo®, Twitch®, Pandora®, Soundcloud®, Tidal®, etc.). This aspect may involve encoding the video and audio to the server and the server providing the encoded video to the audio to another streaming provider which is then provided to the computing device 204.

In operation 304, each computing device 204 determines a delay between the live audio and video streams (e.g., all of the video streams provided from the plurality of cameras 214 and 216). In operation 306, the computing device 204 time aligns/shifts (or synchronizes) the live audio and video streams with one another after the delay is computed and known. For example, once the computing device 204 determines the delay (or playback offset rate) for all the video streams, the computing device 240 adjusts the video streams and the audio streams based on the playback offset rate or delay to temporally align the streams together.

In operation 308, the computing device 204 may then modify the audio and video properties of the synchronized audio and video streams as desired by the user. Any changes performed to the audio stream by the user may correspond to a change in an audio property. Similar, any changes performed to the video stream(s) may correspond to a change in a vide property. For example, the user may selectively modify a single audio stream that includes a single mix of all of the audio being provided by the band at the venue 207 via the computing device 204. Alternatively, the user may selectively modify a single audio stream that pertains to, for example, a guitar track that is provided by the guitarist of the band at the venue 207 via the computing device 204. The computing device 204 may enable the user to select various any number of audio and video tracks. In the event the user desires to see an aggregate video stream of the entire band, the computing device 204 may hide the remaining video streams of individual band members until they are selected for viewing by the user. Similarly, in the event the user desires to listen to the entire mix of the instruments being played by the band, the computing device 204 may mute the individual tracks, for example, for guitar, vocals, drums, and bass guitar until they are individually selected for listening by the user. It is recognized that any one or more audio streams or tracks may be played back at any single instance in time.

FIG. 18 depicts a method 350 for providing a “picture-in-picture stream” for a live performance in accordance with one embodiment.

In operation 352, the computing device 204 receives two or more video streams from the server 202 via the streaming provider. In operation 354, the computing device 204 displays a first video stream of, for example, the entire band during the live performance. As noted above, while the computing device 204 receives two or more video streams from the venue 207, it is recognized that the computing device 204 may playback a single video stream of the two or more video streams. For the example presented in connection with the method 350, one can assume, that the computing device 204 is simply playing back a single video stream that illustrates all band members during the live performance.

In operation 356, the computing device 204 receives a command from the user (via a user interface thereof) to view a second video stream for a particular musician of the band (e.g., guitarist or vocalist) that is performing during the live performance. In operation 358, the computing device 204 plays both the first video stream and the second video stream in real time with no delay between the switching of video content.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system for controlling aspects of a virtual concert, the apparatus comprising:
one or more controllers for being positioned in a venue and being configured to control features of a live performance at the venue based on at least one first signal; and
at least one computing device being programmed to:
receive a second signal indicative of a command to control at least a portion of the live performance from directly from a user that is remote from the venue; and
transmit the at least one first signal to the one or more controllers to control the features of the live performance.

2. The system of claim 1, wherein the one or more controller include a camera controller configured to control one or more cameras positioned at the venue to move to a desired camera angle and to transmit a first video stream of the live performance based on the desired camera angle to the at least one computing device.

3. The system of claim 2, wherein the one or more cameras are positioned directly on a performer at the venue or directly on a musical instrument of the performer.

4. The system of claim 3, wherein the camera controller is further configured to activate the one or more cameras positioned directly on the performer or directly on the musical instrument and to provide a second video stream that corresponds to a captured video stream of the performer or the musical instrument of the performer.

5. The system of claim 2, wherein the at least one computing device is further configured to display a mapping of the cameras as positioned throughout the venue to enable user selection of items on the mapping to control the cameras positioned at the venue.

6. The system of claim 2, wherein the one or more controllers include a lighting controller configured to control aspects related to lighting positioned at the live performance based on the at least one first signal and wherein the camera controller is further configured to transmit a captured video stream depicting the desired changes to the lighting on the live performance to the at least one computing device.

7. The system of claim 6, wherein the lighting positioned at the live performance includes one or more of spotlights, strobe lights, stage lights, and animations.

8. The system of claim 6, wherein the at least one computing device is further configured to display a mapping of the lighting as positioned throughout the venue to enable user selection of items on the mapping to control the lighting positioned at the venue.

9. The system of claim 2, wherein the one or more controllers include a robotic controller to control at least one mechanical prop located at the live performance based on the at least one first signal and wherein the camera controller is further configured to transmit a captured video stream corresponding to movement of the at least one mechanical prop based on the at least one first signal to the at least one computing device.

10. The system of claim 9, wherein the at least one computing device is further configured to display a mapping of the at least one mechanical prop as located at the venue to enable user selection of items on the mapping to control the at least one mechanical prop at the venue.

11. The system of claim 1, wherein the one or more controllers include a first controller configured to control one or more first items corresponding to one or more of pyrotechnics, confetti cannons, video/audio projections on a screen, audio miking, and amplification located at the live performance based on the at least one first signal.

12. The system of claim 11, wherein the audio miking includes one or more binaural microphones positioned at the venue to capture an ambience of an audience at the venue.

13. The system of claim 11, wherein the at least one computing device is further configured to display a mapping of the one or more first items located at the venue to enable user selection of the one or more of pyrotechnics, confetti cannons, video/audio projections on a screen, audio miking, and amplification located at the live performance based on the at least one first signal.

14. The system of claim 1, wherein the at least one computing device is further configured to enable the user to select one or more of cheer credits, ticket tiers, and playlist events.

15. The system of claim 14, wherein the cheer credits correspond to one or more of requests to change stage lighting, votes for songs to be played at the venue, transmissions of personalized messages to performers at the live performance, and requests for the performers to provide a personalized message.

16. The system of claim 14, wherein the ticket tiers correspond to any one or more of the following:
a general admission tier to view the live performance remotely at the at least one computing device;
a reserve seating tier to enable the user to obtain HiFi audio quality while being positioned remotely from the venue;
a front row seating tier to block advertisements from being displayed while the live performance is viewed at the at least one computing device; and
a back stage pass tier to provide autographed items by performers on the stage.

17. The system of claim 14, wherein the playlist events correspond to any one or more of the following:
a superfan shootout event that enables users of a plurality of the computing devices to compete with one another;
a lighters event that enables the user of the at least one computing device to select an option on the respective computing device to trigger a light that represents a user holding up a lighter at the live performance;
decibel meter event that enables the user of the at least one computing device to tap an interface positioned thereon within a predetermined period of time to simulate fans at the live performance repeatedly beating to increase the decibel level provided by the audience; and
a live poll event that enables the user to vote for a performer to perform a predetermined act.

18. The system of claim 1 further comprising a server that is operably coupled to the one or more controllers and the at least one computing device and the server is configured to determine a user prestige amount a plurality of users of a plurality of the computing devices.

19. A method for controlling aspects of a virtual concert, the method comprising:
controlling, via one or more controllers positioned in a venue, features of a live performance at the venue based on at least one first signal;
receiving, at at least one computing device, a second signal indicative of a command to control at least a portion of the live performance from directly from a user that is remote from the venue; and
transmitting the at least one first signal to the one or more controllers to control the features of the live performance.

20. A computer-program product embodied in a non-transitory computer readable medium that is programmed for controller aspects of a virtual concert, the computer-program product comprising instructions for:
controlling, via one or more controllers positioned in a venue, features of a live performance at the venue based on at least one first signal;
receiving, at at least one computing device, a second signal indicative of a command to control at least a portion of the live performance from directly from a user that is remote from the venue; and
transmitting the at least one first signal to the one or more controllers to control the features of the live performance.
